(19) United States
(12) Patent Application Publication
(10) Pub. No.: US 2001/0040186 A1
(43) Pub. Date: Nov. 15, 2001

(54) IC CARD AND A METHOD OF MANUFACTURING AN IC CARD

(76) Inventor: HIROHARU OKADA, KYOTO-SHI (JP)

Correspondence Address: ARENT FOX KINTNER PLOTKIN & KAHN, 1050 Connecticut Avenue, N.W., Suite 600, Washington,, DC, 20036-5339, US

(21) Appl. No.: 09/283,746

(22) Filed: Apr. 2, 1999

(30) Foreign Application Priority Data
Apr. 6, 1998 (JP) H10-93380

(51) Int. Cl. G06K 19/06

(52) U.S. Cl. 235/492

(57) ABSTRACT

An IC card has, inside a card body, an IC chip and an antenna. To prevent breakage of the IC chip by an external bending force applied to the IC card, grooves are formed on both surfaces of the card body so as to surround the IC chip, or the portion of the card body surrounding the IC chip is made thinner than the remaining portions thereof. Even if a bending force is applied to the IC card, the card body bends along the grooves or the thinner portion. This reduces the bending force transmitted to the IC chip and thereby protect it. The grooves or the thinner portion may be formed so as to surround only the IC chip or both the IC chip and the antenna.

### BACKGROUND OF THE INVENTION

1. Field of the Invention

The present invention relates to an IC card incorporating an IC chip, and particularly to a non-contact-type IC card having an antenna coil.

2. Description of the Prior Art

A card incorporating an IC (integrated circuit) is called an IC card, and has a storage capacity scores of times or more as large as a conventional magnetic card. Now, a description will be given of a non-contact-type IC card that is powered by receiving a radio wave by means of a coil-shaped antenna and converting it into electric power on which it operates.

An IC card has a card body that is approximately 0.76 mm thick and made of resin such as vinyl chloride or PET (polyethylene terephthalate) so as to be flexible. Accordingly, an IC card is susceptible to a bending force applied thereto while in use, and such a bending force sometimes causes breakage of the IC chip incorporated therein. For this reason, it is customary to provide an IC card with a means to prevent breakage of its IC chip.

The structure of a conventional non-contact-type IC card will be described. FIG. 8 shows a schematic top view of an example of a conventional non-contact-type IC card. The IC card has an IC chip 2 embedded in the central portion of its card body 1, and has an antenna coil embedded in the peripheral portion of its card body 1 and connected to the IC chip 2.

Moreover, an annular ceramic frame 8 is arranged around the IC chip 2. Even when a bending force is applied to the IC card, this ceramic frame 8 prevents the IC chip 2 placed inside it from being subjected to the bending force. Note that, in the figure, the IC chip 2 and the antenna coil 3 are illustrated with broken lines because they are embedded in the card body 1 and thus do not appear on the surfaces of the card body 1.

FIG. 9 shows a schematic top view of another example of a conventional non-contact-type IC card. In this IC card, the IC chip 2 is placed in a corner of the card body 1 to avoid the central portion thereof, where the effect of a bending force is greater.

However, manufacturing the IC card shown in FIG. 8 requires an extra member, specifically the ceramic frame 8, and thus also requires an extra step for fitting it. This leads to lower productivity and higher costs. On the other hand, in the IC card shown in FIG. 9, even though the IC chip 2 is placed away from the central portion of the card body 1, where the effect of a bending force is greater, there still exists a risk of the IC chip 2, though placed in a corner of the card body 1, being subjected to a bending force. Thus, sufficient suppression of a bending force cannot be achieved.

### SUMMARY OF THE INVENTION

An object of the present invention is to provide an IC card that achieves sufficient suppression of a bending force applied to the IC chip incorporated therein despite having a simple structure.

To achieve the above object, according to one aspect of the present invention, in an IC card having, inside a card body, an IC chip and an antenna coil connected to the IC chip, grooves are formed on both surfaces of the card body so as to surround the IC chip.

According to another aspect of the present invention, in an IC card having, inside a card body, an IC chip and an antenna coil connected to the IC chip, a portion of the card body surrounding the IC chip is made thinner than remaining portions of the card body.

When a bending force is applied to these IC cards, the card body bends along the grooves or the thinner portion, leaving the portion surrounded by the grooves or the thinner portion, i.e. the portion around where the IC chip is embedded, scarcely bent. This helps prevent breakage of the IC chip. In particular, the structure in which a portion of the card body is made thinner allows the IC card to have smooth surfaces and thus have good looks and a good feel.

The grooves or the thinner portion may be formed so as to surround only the IC chip or both the IC chip and the antenna.

Either of the above-described IC cards can be manufactured by bonding together two base members, which constitute a card body, with an IC chip and an antenna coil sandwiched between them. In this case, the two base members each have a groove or a depression formed previously in the outer surface thereof.

Alternatively, either of the above-described IC cards can be manufactured by placing an IC chip and an antenna coil between two dies, then injecting resin, which constitutes a card body, between the two dies, and then hardening the resin. In this case, the two dies each have a linear projection or a protrusion, for forming grooves or a thinner portion, formed previously in the inner surface thereof.

### BRIEF DESCRIPTION OF THE DRAWINGS

This and other objects and features of the present invention will become clear from the following description, taken in conjunction with the preferred embodiments with reference to the accompanying drawings in which:

FIG. 1A is a schematic top view of the IC card of a first embodiment of the invention;

FIG. 1B is an enlarged partial sectional view of the IC card of the first embodiment, taken along the line A-A′ shown in FIG. 1A;

FIG. 1C is a schematic diagram showing a state of the IC card of the first embodiment as seen when a bending force is applied thereto;

FIG. 2 is a schematic sectional view of the IC card of the first embodiment as seen during its manufacturing process;

FIG. 3 is a schematic sectional view of the IC card of the first embodiment as seen during the manufacturing process according to another manufacturing method;

FIG. 4 is a schematic top view of the IC card of another embodiment related to the first embodiment;

FIG. 5A is a schematic top view of the IC card of a second embodiment of the invention;

FIG. 5B is an enlarged partial sectional view of the IC card of the second embodiment, taken along the line C-C′ shown in FIG. 5A;

FIG. 6 is a schematic sectional view of the IC card of the second embodiment as seen during its manufacturing process;

FIG. 7 is a schematic top view of the IC card of another embodiment related to the second embodiment;

FIG. 8 is a schematic top view of a conventional IC card; and

FIG. 9 is a schematic top view of another conventional IC card.

### DESCRIPTION OF THE PREFERRED EMBODIMENTS

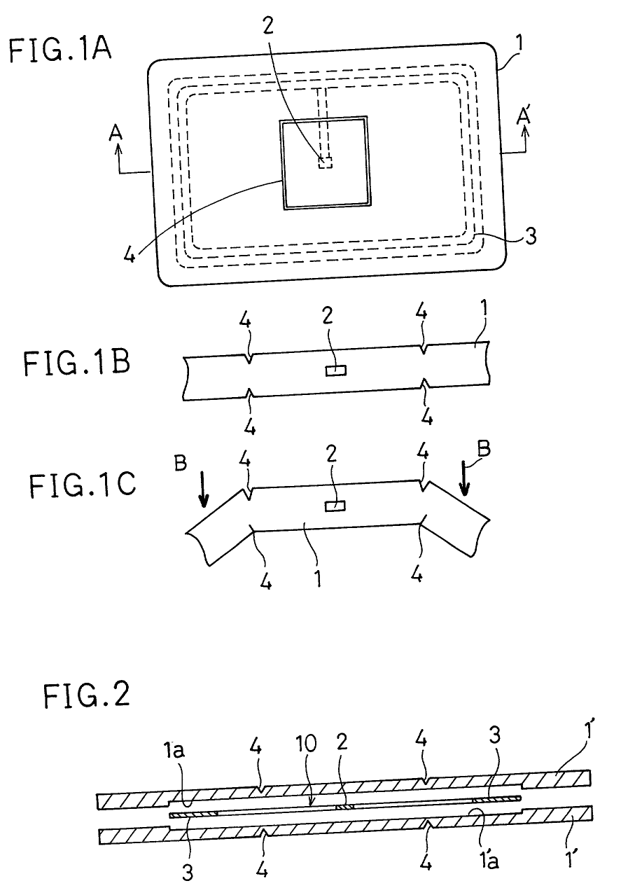

Hereinafter, embodiments of the present invention will be described with reference to the accompanying drawings. FIG. 1A shows a schematic top view of the IC card of a first embodiment of the invention. FIG. 1B shows an enlarged partial sectional view of the same IC card taken along the line A-A′ shown in FIG. 1A. FIG. 1C shows a state of the same IC card as seen when a bending force is applied thereto. Note that, in these and later-described figures, such elements as are found also in the conventional examples described earlier are identified with the same reference symbols, and overlapping descriptions will not be repeated.

As shown in FIGS. 1A and 1B, in each of the top and bottom surfaces of a card body 1, a groove 4, having a depth equal to or smaller than a quarter of the thickness of the card body 1, is formed between an IC chip 2 and an antenna coil 3 so as to surround the IC chip 2. As shown in FIG. 1C, when a bending force is applied to this IC card (as indicated by the arrows B in the figure), the card body 1 bends along the grooves 4, leaving the portion surrounded by the grooves 4, where the IC chip 2 is embedded, scarcely bent. Such reaction of the IC card against a bending force applied thereto helps prevent breakage of the IC chip 2. In this embodiment, since the grooves 4 are so formed as to have a depth equal to or smaller than a quarter of the thickness of the card body 1, there is no risk of the IC card breaking along the grooves 4 as a result of bending fatigue.

In the IC card of this embodiment, the grooves 4 are so formed as to have a V-shaped section and describe a closed square. However, the grooves 4 may be formed in any other way, for example so as to have a semicircular section and describe a circle around the IC chip 2, as long as they can prevent a bending force from being applied to the IC chip 2.

A method of manufacturing the IC card of this embodiment will be described. FIG. 2 shows a schematic sectional view of the IC card as seen during its manufacturing process. According to this method, the card body 1 shown in FIG. 1A is formed by bonding together two card base members 1′. The two card base members 1′ each have a flat recess 1′a formed in one surface thereof, and have a groove 4 as shown in FIG. 1 formed in that portion of the other surface thereof which lies just behind the recess 1′a.

The IC chip 2 and the antenna coil 3 are, along with other electronic devices and components, integrated together to form an IC module 10. The card base members 1′ are bonded together with their respective surfaces on which the recesses 1′a are formed facing each other and with the IC module 10 sandwiched between them so as to be fitted inside the recesses 1′a.

The card base members 1′ are bonded together, for example, with adhesive, or, since they are made of resin, by heat. According to this method of manufacturing the IC card, the card base members 1′ each have the groove 4 formed previously on one surface thereof; however, it is also possible to form the grooves 4 by machining after the card base members 1′ are bonded together.

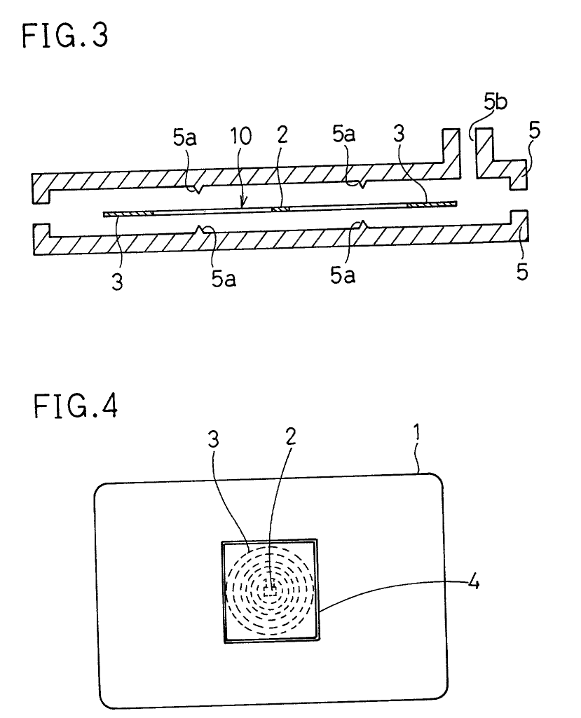

Another method of manufacturing the IC card will be described. FIG. 3 shows a schematic sectional view of the IC card as seen during its manufacturing process. According to this method, the card body 1 is molded by the use of dies 5. The upper and lower dies 5 each have a linear projection 5a formed on the inner surface thereof. The projections 5a are so formed as to have a V-shaped section and describe a closed square. By these projections 5a, grooves 4 as shown in FIG. 1 are formed on the top and bottom surfaces of the card body 1 that is going to be produced.

In a predetermined position inside the dies 5, the IC module 10, which is formed by integrating together the IC chip 2, the antenna coil 3, and other electronic devices and components, is placed. Then, resin is injected into the inside of the dies 5 through a resin injection opening 5b, and is then hardened. In this way, a card body 1 is obtained that incorporates the IC module 10, i.e. the IC chip 2 and the antenna coil 3.

In the above-described method of manufacturing the IC card, how the card base members are bonded together with the IC chip and the antenna coil sandwiched between them and how the card body is formed integrally is the same as in conventional methods of manufacturing IC cards. This embodiment is unique in that the dies for forming the card base members or the card body are provided with projections for forming grooves, and such dies can be produced easily. In this embodiment, resin is injected into the inside of the dies; however, it is also possible to first fill the lower die 5 with resin, then place the IC module 10 thereon, then apply more resin thereover and harden the resin, and then press it from above with the upper die that has a projection 5a formed thereon.

FIG. 4 shows another embodiment related to the IC card of the first embodiment. In this IC card, as in the first embodiment, grooves 4 are formed in the top and bottom surfaces of the card body 1. In the portion surrounded by the grooves 4 are provided an IC chip 2 and an antenna coil 3 connected to the IC chip 2. In this way, even if the grooves 4 are formed outside the antenna coil 3, it is still possible to prevent a bending force from being applied to the IC chip 2.

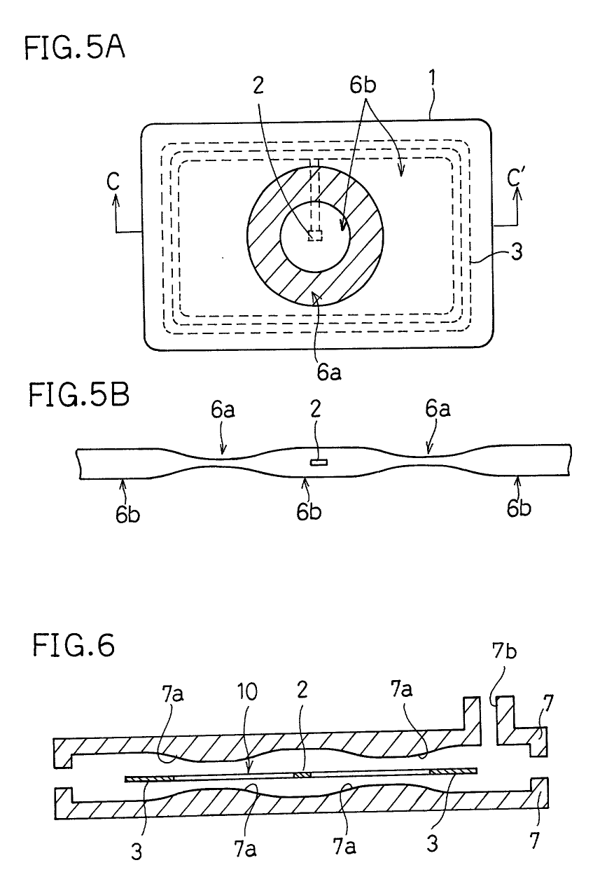

Now, the IC card of a second embodiment of the invention will be described. FIG. 5A shows a schematic top view of the IC card of this embodiment. FIG. 5B shows an enlarged partial sectional view of the same IC card taken along the line C-C′ shown in FIG. 5A. In this embodiment, a card body 1 is so formed as to be thinner in an annular portion 6a (hatched in the figure) around an IC chip 2 than in the remaining portions 6b. Between this annular portion 6a and the remaining portions 6b, the thickness of the card body 1 varies smoothly.

When a bending force is applied to this IC card, the card body 1 bends along the annular portion 6a, which is made thinner, leaving the central portion 6b, where the IC chip 2 is embedded, scarcely bent. Such reaction of the IC card against a bending force applied thereto helps reduce the possibility of breakage of the IC chip 2.

In this embodiment, as shown in FIG. 5B, the card body 1 has depressions formed in both of its top and bottom surfaces, along the annular portion 6a, which is made thinner. Alternatively, it is also possible to form such a depression in only one of the top and bottom surfaces and thereby make the annular portion 6a of the card body 1 thinner. However, when a bending force is applied in a direction in which it tends to make concave the surface which is originally flat with no depression formed thereon, the central portion 6b, where the IC chip 2 is embedded, is more likely to be bent by the bending force than when a bending force is applied in a direction in which it tends to make concave the surface on which a depression is formed. That is, how the card body is susceptible to a bending force varies depending on the direction in which the bending force is applied. Accordingly, it is preferable to form depressions on both of the top and bottom surfaces of the card body 1 as in this embodiment.

A method of manufacturing the IC card of the second embodiment will be described. FIG. 6 shows a schematic sectional view of the IC card as seen during its manufacturing process. According to this method, the card body 1 is molded by the use of dies 7. The upper and lower dies 7 each have a smooth projection 7a formed on the inner surface thereof. The projections 7a are so formed as to describe an annular shape. By these projections 7a, the card body 1 that is going to be produced is made thinner in the annular portion 6 shown in FIG. 5A in both the top and bottom surfaces thereof.

In a predetermined position inside the dies 7, the IC module 10, which is formed by integrating together the IC chip 2, the antenna coil 3, and other electronic devices and components, is placed. Then, resin is injected into the inside of the dies 7 through a resin injection opening 7b, and is then hardened. In this way, a card body 1 is obtained that incorporates the IC module 10, i.e. the IC chip 2 and the antenna coil 3.

In the above-described method of manufacturing the IC card, how the card body is formed integrally is the same as in conventional methods of manufacturing IC cards. This embodiment is unique in that the dies for forming the card body are provided with projections for forming the thinner portion of the card body, and such dies can be produced easily.

The IC card of this embodiment can be manufactured also by bonding together two card base members with an IC module 10 sandwiched between them, just as described in connection with FIG. 2. In that case, the card base members each have a smooth annular depression formed previously on the outer surface thereof.

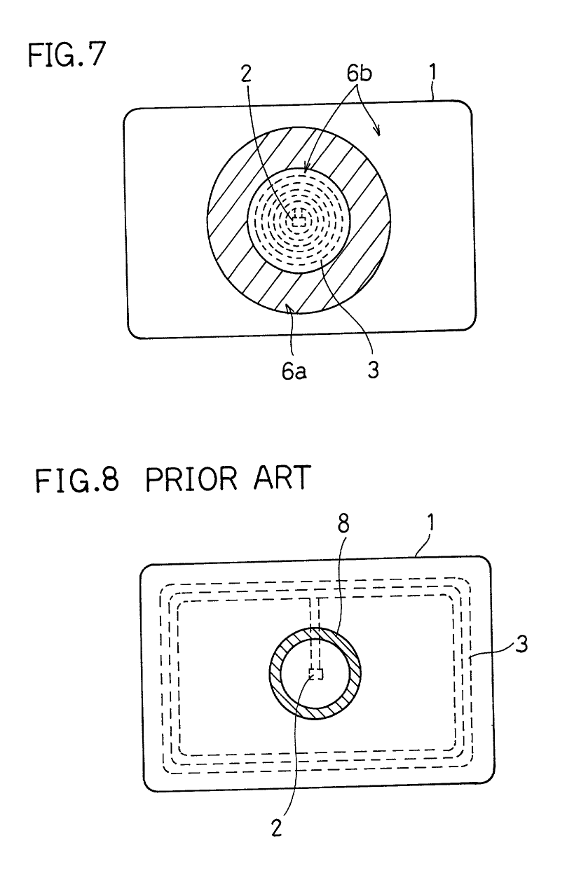

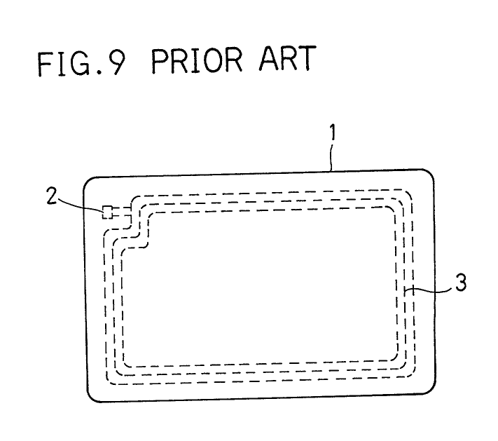

FIG. 7 shows another embodiment related to the IC card of the second embodiment. In this IC card, as in the second embodiment, the card body 1 is so formed as to be thinner in an annular portion 6a than in the remaining portions 6b. In the central portion 6b surrounded by the annular portion 6a, which is made thinner, are provided an IC chip 2 and an antenna coil 3 connected to the IC chip 2. In this way, even if the annular portion 6a, which is made thinner, is formed outside the antenna coil 3, it is still possible to prevent a bending force from being applied to the IC chip 2.

Obviously, many modifications and variations of the present invention are possible in light of the above teachings. It is therefore to be understood that within the scope of the appended claims, the invention may be practiced other than as specifically described.

What is claimed is:

1. An IC card having, inside a card body, an IC chip and an antenna coil connected to the IC chip,
wherein grooves are formed on both surfaces of the card body so as to surround the IC chip.

2. An IC card as claimed in claim 1
wherein the antenna coil is provided around the IC chip, and the grooves are formed between the IC chip and the antenna coil.

3. An IC card as claimed in claim 1,
wherein the antenna coil is provided around the IC chip, and the grooves are formed outside the antenna coil.

4. An IC card having, inside a card body, an IC chip and an antenna coil connected to the IC chip,
wherein a portion of the card body surrounding the IC chip is made thinner than remaining portions of the card body.

5. An IC card as claimed in claim 4,
wherein the thinner portion of the card body forms depressions on both surfaces of the card body with respect to the remaining portions of the card body.

6. An IC card as claimed in claim 4,
wherein the antenna coil is provided around the IC chip, and the thinner portion of the card body is formed between the IC chip and the antenna coil.

7. An IC card as claimed in claim 4,
wherein the antenna coil is provided around the IC chip, and the thinner portion of the card body is formed outside the antenna coil.

8. A method of manufacturing an IC card as claimed in claim 1, comprising:
a step of producing two base members of which each has a flat recess formed in one surface thereof and has a linear groove formed in the other surface thereof; and
a step of bonding together the two base members with their respective recesses facing each other and with an IC module including the IC chip and the antenna coil placed inside the recesses.

9. A method of manufacturing an IC card as claimed in claim 1, comprising;
a step of producing two dies of which each has a linear projection formed on a surface thereof that faces the other; and
a step of placing an IC module including the IC chip and the antenna coil between the two dies, then injecting resin between the two dies, and then hardening the resin.

10. A method of manufacturing an IC card as claimed in claim 4, comprising:
a step of producing two base members of which each has a flat recess formed in one surface thereof and has a smooth depression formed in the other surface thereof; and
a step of bonding together the two base members with their respective recesses facing each other and with an IC module including the IC chip and the antenna coil placed inside the recesses.

11. A method of manufacturing an IC card as claimed in claim 4, comprising;
a step of producing two dies of which each has a smooth protrusion formed on a surface thereof that faces the other; and
a step of placing an IC module including the IC chip and the antenna coil between the two dies, then injecting resin between the two dies, and then hardening the resin.
